(19) United States
(12) Patent Application Publication
(10) Pub. No.: US 2005/0075893 A1
(43) Pub. Date: Apr. 7, 2005

(54) Method and system for obtaining and financing exclusive real estate listings

(76) Inventor: Jack Wasserman, Southampton, NY (US)

Correspondence Address: Steven B. Pokotilow;Stroock & Stroock & Lavan LLP, 180 Maiden Lane, New York, NY, 10038, US

(21) Appl. No.: 10/678,871

(22) Filed: Oct. 3, 2003

(51) Int. Cl. G06F 17/60

(52) U.S. Cl. 705/1

(57) ABSTRACT

A method of obtaining a seller's exclusive real estate listing for a property. The method comprises providing consideration to the seller, for example, in the form of an up-front payment, and receiving from the seller the exclusive real estate listing of the property, the exclusive real estate listing being for an exclusivity time period. If a sale condition, such as receipt of a bona fide purchase offer or a contract for sale, for the property is met during the exclusivity time period, the real estate agent receives return consideration, such as a refund of at least a portion of the consideration.

### BACKGROUND OF THE INVENTION

1. Field of the Invention

The present invention relates generally to real estate transactions and, more specifically, to methods and systems for real estate agents to obtain and/or finance exclusive real estate listings.

2. Description of Related Art

In the current residential real estate industry, real estate companies offer home owners essentially two options to sell their properties: either an exclusive listing of the property or a non-exclusive listing. An exclusive contract, or listing, involves a contractual arrangement between the real estate company and seller pursuant to which the company has the exclusive right to sell the property for a specified duration of time, typically a number of months. A non-exclusive arrangement, on the other hand, permits the seller to hire other real estate companies to sell the property. In return for listing the property, the real estate company, and the agents working for them, obtain a commission, usually a percentage of the selling price of the property.

The real estate company much prefers an exclusive listing. With an exclusive listing, the real estate company is more likely to recoup its investment in advertising, or listing, the property. However, there is a tension between the real estate company's goal of obtaining an exclusive listing and the seller's desire. Sellers frequently believe that an exclusive listing is disadvantageous: with only one company advertising and showing the property, fewer potential buyers view the property. With fewer buyers, selling the property is less likely and, if the property is sold, the lack of competition is likely to result in a lower selling price.

Accordingly, there exists a need for an improved method for listing real estate properties and, more specifically, for exclusive listings.

### SUMMARY OF THE INVENTION

The present invention satisfies the foregoing, as well as other, needs. A method of obtaining a seller's exclusive real estate listing for a property according to one embodiment includes a real estate agent providing consideration to the seller, for example, in the form of an up-front payment, and receiving from the seller the exclusive real estate listing of the property, the exclusive real estate listing being for an exclusivity time period. If a sale condition, such as receipt of a bona fide purchase offer or a contract for sale, is met during the exclusivity time period, the real estate agent will receive return consideration, such as a refund of at least a portion of the consideration.

### BRIEF DESCRIPTION OF THE DRAWINGS

FIG. 1 is a schematic illustrating the method according to one embodiment of the present invention.

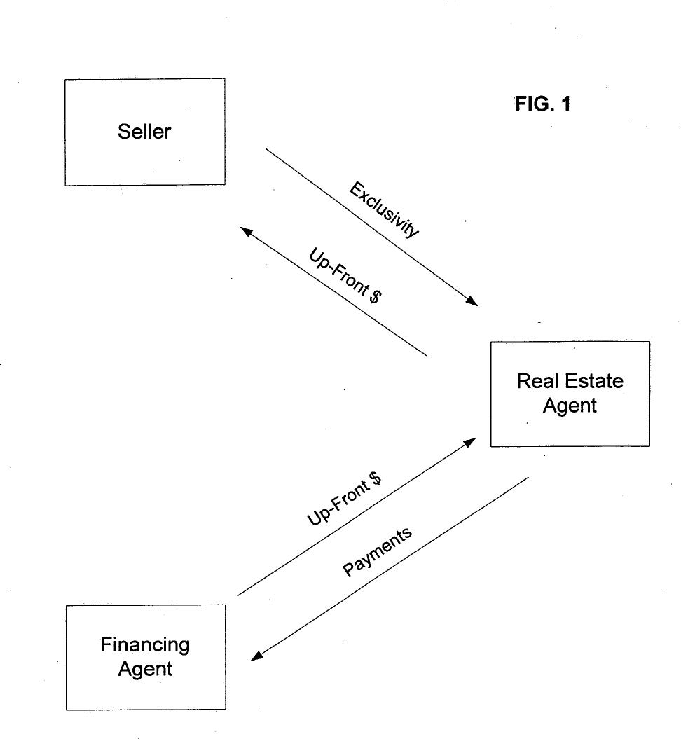

### DETAILED DESCRIPTION OF CERTAIN EMBODIMENTS

Certain embodiments of the present invention will now be described with reference to the foregoing figure. As an initial matter, although the embodiments disclosed herein are described in the context of residential real estate, it is to be understood that the present invention is applicable to all types of real estate, including, for example, commercial real estate, land, single family homes, condominiums, cooperatives, rental properties, and the like.

In general, the present embodiment provides for a contractual arrangement between the seller (or seller's agent) and real estate agent (which is meant to encompass companies and other real estate entities), pursuant to which the seller grants the agent an exclusive for the seller's property, as well as a contractual arrangement between the agent and a financing agent, pursuant to which the agent finances its arrangement with the seller.

More specifically, the seller and real estate agent enter a contract (referred to herein as a “seller's contract”) pursuant to which the seller grants the agent an exclusive right to sell and otherwise list the seller's property. Such exclusivity preferably is for a fixed amount of time, for example, between six and eighteen months, although the exclusivity time period may be longer, for example, until a sale condition (as described below) is satisfied. In return, the real estate agent gives the seller consideration for the grant of exclusivity, thereby providing the seller with an incentive to grant the real estate agent the exclusive listing. In the present embodiment, the consideration is in the form of an up-front payment, although other consideration may be used, such as one or more payments over time, goods, services, and other types of consideration.

The contract further provides that the seller may keep the payment if the agent fails to sell the property and must provide the real estate agent with return consideration if the agent sells the property. It is to be understood that the contract may define any other sale condition as triggering the return consideration, including, for example, the seller receiving a bona fide offer, the seller being under contract to sell the property, and the like. Furthermore, the occurrence of a sale condition may occur during the exclusivity time period or after the period, for example, where, after the exclusivity time period expires, a bona fide offer is received from, or a contract for sale is entered with, a buyer that the real estate agent originally introduced to the seller/property during the exclusivity time period. In the event the property is sold during the term of exclusivity specified in the contract, the seller refunds the payment. Thus, in the present embodiment, at least a portion of the consideration provided to the seller is a payment contingent upon the failure to satisfy the sale condition for the property.

The return consideration may take any number of forms, including, for example, the seller providing the real estate agent a full or partial refund of the consideration given to the seller. Rather than returning the payment (or other consideration), the real estate agent may simply include terms in the seller's contract providing for an accounting at closing of the sale, whereby the purchase price is offset with the amount to be refunded. The contract may provide for all or a portion of the up-front payment to the seller to be held in escrow to ensure all or a portion is available to be refunded. In certain embodiments, the consideration to the seller is an advance of a portion of the listing, market or anticipated sale price of the property; if the sale condition is not satisfied, the seller retains the advance. In still other embodiments, in the event the real estate agent satisfies the sale condition, the return consideration takes the form of an increased commission.

It should be understood that in certain embodiments the seller does not return (or have offset) the entire amount received from the real estate agent. For example, in certain embodiments, as an added incentive to provide the exclusive listing, the seller is able to retain a portion of the consideration.

As will be appreciated by those skilled in the art, the real estate agent recognizes a benefit not only from executing seller's contracts, but also from being able to offer seller's contracts as an alternative to traditional listing contracts with sellers. For example, because the seller's contract provides the seller with the potential of receiving the consideration, the real estate agent is justified in charging a higher commission in connection with the seller's contract, as compared to traditional exclusive listing contracts offered by the real estate agent. Conversely, if potential seller's believe the commission associated with the seller's contract is to high, the real estate agent can offer the lower commission, standard contract.

In the present embodiment, the real estate agent also enters into a contract with a financing agent (referred to herein as a “financing contract”). The financing agent may be a wholly separate agent or may be related to the real estate agent. Pursuant to the financing contract, the financing agent provides the real estate agent with a loan, in the form of an up-front payment, in return for a series of payments over time. In general, the financing contract is a mechanism by which the real estate agent finances payments to the seller under the seller's contract. As will be appreciated by those skilled in the art, each contract between the real estate agent and a financing agent may cover one or more seller's contracts.

Practically, the real estate agent receives a loan from the financing agent in an amount sufficient to make payment on its outstanding or anticipated seller's contracts. The risk assumed by the financing agent depends, in part, on the likelihood the real estate agent selling the property that is subject to the seller's contract and, based on the sale, receiving a return of the up-front payment to the seller and its negotiated sales commission. Other risk factors include the general condition of the real estate market, the financial strength of the real estate agent, and the like. The payments made by the real estate agent over time may equal a return of the principal plus an agreed to interest amount reflective of the risk assumed by the financing agent, for example 1-2% of the amount of the up-front payment.

The financing contract of the present embodiment further provides for a date upon which the financing loan becomes due. Such date may be relative to the date on which the periods of exclusivity under the real estate agent's contracts with one or more sellers expire, may be based on certain calendar dates, such as quarterly, bi-annually, annually, or any other negotiated date. Any portion of the loan payments due to the financing agent may be payable at the due date, as reflected in the financing contract.

In other embodiments, the payments from the real estate agent may equal a percentage of the real estate agent's anticipated commissions from the sale of properties covered by one or more seller's contracts. In return for an up-front financing payment, the financing agent has a contractual right to a portion of the future cash flow of the real estate agent. As such, the financing agent assumes a role similar to that of a factor.

The financing agent may simply collect its portion of these future payments, or it may issue derivative securities based on these future payments. Such derivatives may be segregated into any of a number of pools or traunches, for example, by date of expiration of the underlying seller's contracts, geographic market of the properties being sold, market value of properties being sold, type of property being sold, particular real estate agent, the interest rate charged by the financing agent and the like.

It should be understood that although the primary embodiment has been described in the context of a single seller and real estate agent, it is equally applicable to the agent contracting with multiple potential sellers. Similarly, although a single financing agent is described as contracting with one real estate agent, the present embodiment is applicable to one or more financing agents contracting with one or more real estate companies. Indeed, it is anticipated that a single financing agent will contract with multiple real estate companies, thereby diversifying its risk. Also, there is no requirement that a real estate agent use a financing agent or otherwise obtain financing.

It should be understood that the present embodiment can be implemented in large part by a computer system. For example, the real estate agent may utilize a specially programmed computer to track seller's and financing contracts, as well as its performance in selling properties by the termination of their respective exclusivity periods. One such computer implementation includes a programmed personal computer or server having associated electronic storage. The electronic storage includes a database for storing the details of the seller's and financing contracts. More specifically, the database includes one or more tables and fields for: identifying each seller's contract and, for each such contract, specifying the seller, seller's property, period of exclusivity and termination of such period, amount of the payment to the seller, negotiated commission, and any other parameters of the contract deemed relevant; and identifying each financing contract and, for each such contract, specifying the financing agent, the amount received, the payments owed and any other parameters deemed relevant. Where a financing contract relates to one or more specific seller's contracts, the database also indicates such relationships.

A program running on the computer provides certain functionality. For example, the program provides an information entry screen through which employees enter contract information. The program also causes the computer to run various reports, including summaries of payments due, exclusivity expiration dates, exclusivity expiration dates for properties not yet sold, sales made, commissions earned, commissions collected, and any other reports deemed relevant. The program may also include a payment system for automatically generating checks payable to one or more financing agents.

The financing agent may also implement certain functionality in a similar computer system, for example, to track its financing contracts with one or more real estate companies and the underlying seller's contracts.

Those skilled in the art will recognize that the method and system of the present invention has many applications, may be implemented in many manners and, as such, is not to be limited by the foregoing exemplary embodiments and examples. In this regard, any number of the features of the different embodiments described herein may be combined into one single embodiment. Moreover, the scope of the present invention covers conventionally known and future developed variations and modifications to the system components described herein, as would be understood by those skilled in the art.

1. A method for a real estate agent to obtain a real estate listing for a property of a seller, the method comprising:
providing consideration to the seller;
receiving from the seller the real estate listing of the property in return for providing the consideration to the seller; and
receiving return consideration from the seller if a sale condition for the property is met.

2. The method of claim 1, wherein the consideration includes an up-front payment to the seller.

3. The method of claim 1, wherein the sale condition is receipt of a bona fide offer to purchase the property.

4. The method of claim 1, wherein the sale condition is an executed purchase contract.

5. The method of claim 1, further comprising not receiving the return consideration refund if the sale condition is not met.

6. The method of claim 1, wherein receiving return consideration includes receiving a refund of at least a portion of the consideration.

7. The method of claim 1, wherein receiving return consideration includes offsetting a purchase price for the property with the refund.

8. The method of claim 1, wherein receiving return consideration includes the real estate agent increasing a commission received from the seller.

9. The method of claim 1, wherein the property has an associated price and providing consideration to the seller includes providing an advance of the price, and wherein receiving return consideration includes offsetting monies provided to the seller based on sale of the property by the advance.

10. The method of claim 1, wherein:
the providing consideration includes providing consideration to a plurality of sellers;
the receiving the listing includes receiving listings from the plurality of sellers; and
the receiving a refund includes receiving a refund from a group of the plurality of sellers for which a corresponding sale condition is met.

11. The method of claim 1, wherein the listing is an exclusive listing.

12. The method of claim 10 wherein the group of sellers have different sale conditions.

13. The method of claim 1, further comprising receiving financing from a financing agent.

14. The method of claim 13, further comprising using the financing to provide consideration to the seller.

15. The method of claim 13, further comprising making payment in return for receiving the financing.

16. The method of claim 15, wherein the payment in return for the financing includes paying a percentage of the financing.

17. The method of claim 15, wherein the payment in return for the financing includes paying a percentage of commissions for sale of one or more properties.

18. (Cancelled)

19. (Cancelled)

20. A method of a real estate agent to obtain a real estate listing for a property of a seller, the method comprising:
offering the seller a first arrangement wherein the real estate agent obtains the listing for the property and an opportunity to receive a first commission; and
offering the seller a second arrangement wherein the real estate agent obtains the listing for the property and an opportunity to receive a second commission, the second commission being greater than the first commission, and wherein the seller receives consideration for providing the listing, the consideration not being included in the first arrangement.

21. The method of claim 20, wherein at least one of the arrangements includes the real estate agent obtaining an exclusive real estate listing.

22. A method for a real estate agent to obtain a real estate listing for a property of a seller, the method comprising:
providing up-front consideration to the seller;
receiving from the seller the real estate listing of the property in return for the up-front consideration; and
allowing the seller to retain at least a portion of the consideration if a sale condition is not met.

23. The method of claim 22, wherein the real estate listing is an exclusive real estate listing.

24. The method of claim 22, wherein the consideration includes one or more of the following: money; goods; or services.

25. The method of claim 22, wherein the seller is allowed to retain at least a portion of the consideration if the sale condition is not met during a time period.

26. The method of claim 25, wherein the real estate listing is an exclusive real estate listing for an exclusivity time period and wherein the time period and the exclusivity time period are the same.

27. The method of claim 22, wherein the sale condition includes one or more of the following: receipt of a bona fide offer to purchase the property; an executed purchase contract; or sale of the property.

28. A method for a real estate agent to obtain a real estate listing for a property of a seller, the method comprising:
providing up-front consideration to the seller;
receiving from the seller the real estate listing of the property in return for the up-front consideration;
receiving a refund of at least a portion of the consideration from the seller if a sale condition is met; and
allowing the seller to retain at least a portion of the consideration if the sale condition is not met.

29. The method of claim 28, wherein the real estate listing is an exclusive real estate listing.

30. The method of claim 28, wherein the consideration includes one or more of the following: money; goods; or services.

31. The method of claim 28, wherein the seller is allowed to retain at least a portion of the consideration if the sale condition is not met during a time period.

32. The method of claim 31, wherein the real estate listing is an exclusive real estate listing for an exclusivity time period and wherein the time period and the exclusivity time period are the same.

33. The method of claim 28, wherein the sale condition includes one or more of the following: receipt of a bona fide offer to purchase the property; an executed purchase contract; or sale of the property.

34. A method of a real estate agent to obtain a real estate listing for a property of a seller, the method comprising:
offering a seller a first arrangement wherein the real estate agent obtains the listing for the property of the seller and receives a first commission from the seller if a first sale condition is met; and
offering the seller a second arrangement wherein the real estate agent obtains the listing for the property and receives a second commission if a second sale condition is met, and wherein the seller receives consideration in return for the listing, the consideration not being included in the first arrangement, and wherein the seller keeps at least a portion of the consideration if the second sale condition is not met.

35. The method of claim 34, wherein at least one of the arrangements includes the real estate agent obtaining an exclusive real estate listing.

36. The method of claim 34, wherein the second commission is greater than the first commission.

37. The method of claim 34, wherein the first commission is equal to the second commission. 1

38. The method of claim 34, wherein the first sale condition or the second sale condition includes one or more of the following: receipt of a bona fide offer to purchase the property; an executed purchase contract; or sale of the property.

39. The method of claim 34, wherein the first sale condition is the same as the second sale condition.

40. The method of claim 34, wherein the first sale condition is different than the second sale condition.

41. The method of claim 34, wherein in the second arrangement, the consideration includes an up-front payment to the seller.

42. The method of claim 34, wherein in the second arrangement, the consideration includes one or more of the following: money; goods; or services.

43. The method of claim 34, wherein in the second arrangement, the seller keeps at least a portion of the consideration if the second sale condition is not met during a time period.

44. The method of claim 43, wherein in the second arrangement, the listing is an exclusive real estate listing for an exclusivity time period and wherein the time period and the exclusivity time period are the same.

45. A method for a real estate agent to obtain a real estate listing for a property of a seller, the method comprising the steps of:
determining up-front consideration to be given to the seller;
receiving from the seller the real estate listing of the property in return for the up-front consideration;
determining whether the seller is allowed to retain at least a portion of the consideration, the determination being based on whether a sale condition is met; and
wherein at least a part of one of the steps utilizes a computer.

46. The method of claim 45, wherein the real estate listing is an exclusive real estate listing.

47. The method of claim 45, wherein the consideration includes one or more of the following: money; goods; or services.

48. The method of claim 45, wherein the sale condition includes one or more of the following: receipt of a bona fide offer to purchase the property; an executed purchase contract; or sale of the property.

49. The method of claim 45, wherein the determination being based on whether a sale condition is met is based on whether the sale condition is met during a time period.

50. The method of claim 49, wherein the real estate listing is an exclusive real estate listing for an exclusivity time period and wherein the time period and the exclusivity time period are the same.

51. A system for tracking seller contracts, each contract providing for a real estate agent to receive a listing for a property of a seller in return for the seller receiving up-front consideration for the listing, the seller retaining at least a portion of the up-front consideration if a sale condition is not met during a time period, the system comprising:
one or more processors coupled to electronic storage, the processors programmed to:
associate with each seller contract an indication of the up-front consideration to the seller and an indication of the time period; and
track expiration of the time period, thereby enabling a determination of whether the seller retains at least a portion of the up-front consideration.

52. The method of claim 51, wherein the listing is an exclusive listing.

53. The system of claim 51, wherein the listing is an exclusive listing for an exclusivity time period, and wherein the time period equals the exclusivity time period;

54. The system of claim 51, wherein the consideration includes one or more of the following: money; goods; or services.

55. The method of claim 51, wherein the sale condition includes one or more of the following: receipt of a bona fide offer to purchase the property; an executed purchase contract; or sale of the property.

56. The method of claim 51, wherein the up-front consideration is received by the seller prior to the sale of the property.

57. The method of claim 56, wherein the up-front consideration is received by the seller when the seller provides the listing to the real estate agent.

58. A method for a real estate agent to obtain a real estate listing for a property of a seller, the method comprising the steps of:
offering the seller a first arrangement wherein the real estate agent obtains the listing for the property and an opportunity to receive a first commission;
offering the seller a second arrangement wherein the real estate agent obtains the listing for the property and an opportunity to receive a second commission, and wherein the seller receives consideration in return for providing the second listing, the consideration not being included in the first arrangement; and
determining the commission and consideration based on an arrangement selected by the seller;
wherein at least a part of one of the steps utilizes a processor.

59. The method of claim 58, wherein at least one of the arrangements includes the real estate agent obtaining an exclusive real estate listing.

60. The method of claim 58, wherein the second commission is greater than the first commission.

61. The method of claim 58, wherein the first commission is equal to the second commission.

62. The method of claim 58, wherein the first sale condition or the second sale condition includes one or more of the following: receipt of a bona fide offer to purchase the property; an executed purchase contract; or sale of the property.

63. The method of claim 58, wherein the first sale condition is the same as the second sale condition.

64. The method of claim 58, wherein the first sale condition is different than the second sale condition.

65. The method of claim 58, wherein in the second arrangement, the consideration includes an up-front payment to the seller.

66. The method of claim 58, wherein in the second arrangement, the consideration includes one or more of the following: money; goods; or services.

67. The method of claim 58, wherein in the second arrangement, the seller keeps at least a portion of the consideration if the second sale condition is not met during a time period.

68. The method of claim 67, wherein in the second arrangement, the listing is an exclusive listing for an exclusivity time period and wherein the time period and the exclusivity time period are the same.

69. A system for tracking at least two arrangements for a real estate agent to obtain real estate listings for properties of sellers, the system comprising:
one or more processors coupled to electronic storage, the processors programmed to:
associate either a first arrangement or a second arrangement with a seller, wherein the first arrangement comprises the real estate agent obtaining the listing for a property and an opportunity to receive a first commission, and wherein the second arrangement comprises the real estate agent obtaining the listing for the property and an opportunity to receive a second commission, the second commission being greater than the first commission, and the seller receiving consideration in return for providing the second listing, the consideration not being included in the first arrangement; and
associate arrangements with commissions and consideration, if any, thereunder.

70. The method of claim 69, wherein at least one of the arrangements includes the real estate agent obtaining an exclusive real estate listing.

71. The system of claim 69, wherein at least one of the arrangements includes the real estate agent obtaining an exclusive real estate listing for an exclusivity time period.

72. The system of claim 69, wherein in the second arrangement, the consideration includes one or more of the following: money; goods; or services.

73. The method of claim 69, wherein in the second arrangement, at least a portion of the consideration is retained by the seller if a sale condition is met.

74. The method of claim 69, wherein in the second arrangement, the sale condition includes one or more of the following: receipt of a bona fide offer to purchase the property; an executed purchase contract; or sale of the property.

75. The method of claim 69, wherein in the second arrangement, the consideration is up-front consideration.

76. The method of claim 75, wherein in the second arrangement, the up-front consideration is received by the seller prior to the sale of the property.

77. The method of claim 75, wherein in the second arrangement, the up-front consideration is received by the seller when the seller provides the second listing to the real estate agent.

78. The method of claim 1, wherein receiving return consideration includes receiving an increased commission as compared to other contracts for real estate listings.

79. The method of claim 1, wherein the receiving return consideration includes receiving the return consideration if the sale condition is met during a time period.

80. The method of claim 79, wherein the real estate listing is an exclusive real estate listing for an exclusivity time period, and wherein the time period equals the exclusivity time period.

81. The method of claim 1, wherein the consideration includes one or more of the following: money; goods; or services.
